(19) United States
(12) Patent Application Publication
(10) Pub. No.: US 2023/0172382 A1
(43) Pub. Date: Jun. 8, 2023

(54) Garlic Press

(71) Applicant: Williams-Sonoma, Inc., San Francisco, CA (US)

(72) Inventor: Karl Edward Ludeman, Oakland, CA (US)

(21) Appl. No.: 18/062,822

(22) Filed: Dec. 7, 2022

Related U.S. Application Data
(60) Provisional application No. 63/287,261, filed on Dec. 8, 2021.

(51) Int. Cl. A47J 19/06

(52) U.S. Cl. CPC A47J 19/06

(57) ABSTRACT

A garlic press includes a base with a first portion adjacent to a first end and an angled elevated portion adjacent to a second end. The first portion of the base is configured to rest on a surface. A handle is pivotally joined to the angled elevated portion of the base at a joint so that the handle may pivot between an open position and a closed position. The handle includes a presser block. The angled elevated portion of the base including a chamber defined by walls and a grate having a number of apertures. The chamber receives the presser block when the handle is in the closed position.

### CLAIM OF PRIORITY

This application claims the benefit of U.S. Provisional Application No.63/287,261, filed Dec. 8, 2021, the contents of which are hereby incorporated by reference.

### FIELD OF THE INVENTION

The present invention relates generally to garlic presses and, more particularly, to a garlic press that can be handheld or used on a countertop or other surface.

### BACKGROUND OF THE INVENTION

Garlic presses are well known in the art. A garlic press functions to crush a garlic clove so that the garlic within the clove is forced out of the press through a grate having small holes. As a result, the peel or skin of the garlic clove is separated from the garlic and remains within the garlic press. The conventional garlic press is designed as a handheld tool with two handles which a user squeezes together to operate. In order to crush the garlic clove effectively, a certain amount of pressure needs to be applied by squeezing the handles together. This requires a certain amount of strength and/or dexterity, which may be problematic for someone with limited strength and/or dexterity.

A garlic press that can provide additional leverage is therefore desirable.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a garlic press includes a base with a first portion adjacent to a first end and an angled elevated portion adjacent to a second end. The first portion of the base is configured to rest on a surface. A handle is pivotally joined to the angled elevated portion of the base at a joint so that the handle may pivot between an open position and a closed position. The handle includes a presser block. The angled elevated portion of the base includes a chamber defined by walls and a grate having a number of apertures. The chamber is configured to receive the presser block when the handle is in the closed position.

### BRIEF DESCRIPTION OF THE DRAWINGS

FIG. 1 is a perspective view of an embodiment of the garlic press of the disclosure with the handle in a closed position.

FIG. 2 is an additional perspective view of the garlic press of FIG. 1.FIG. 3 is a perspective view of the garlic press of FIGS. 1 and 2 with the handle in a partially open position.

FIG. 4 is a perspective view of the garlic press of FIGS. 1, 2 and 3 with the handle in a fully open position.

FIG. 5 is an additional perspective view of the garlic press of FIG. 4.

### DESCRIPTION OF EMBODIMENTS

The embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

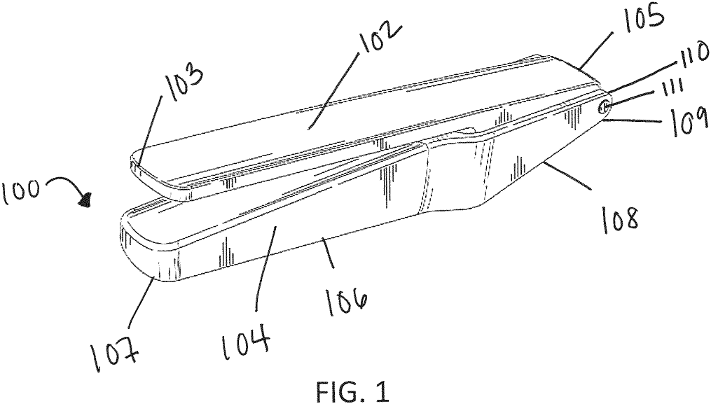

A first embodiment of the garlic press of the disclosure is indicated in general at 100 in FIG. 1. The garlic press 100 includes an elongated base 104. The base includes a first end 107 and second end 109. The base has a first portion 106 near the first end 107 with a flat bottom side. The other end of the base 109 has an adjacent angled elevated portion 108. The angle 130 of the elevated portion is acute and permits crushed or minced garlic from a garlic clove to exit the press and collect on a surface 150, such as a tabletop or countertop, while the skin or peel of the garlic clove remains inside the device.

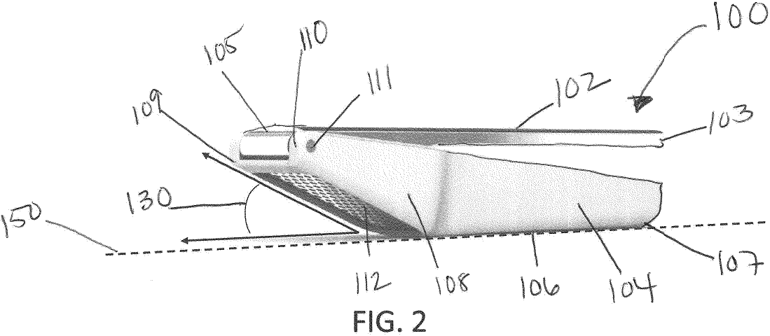

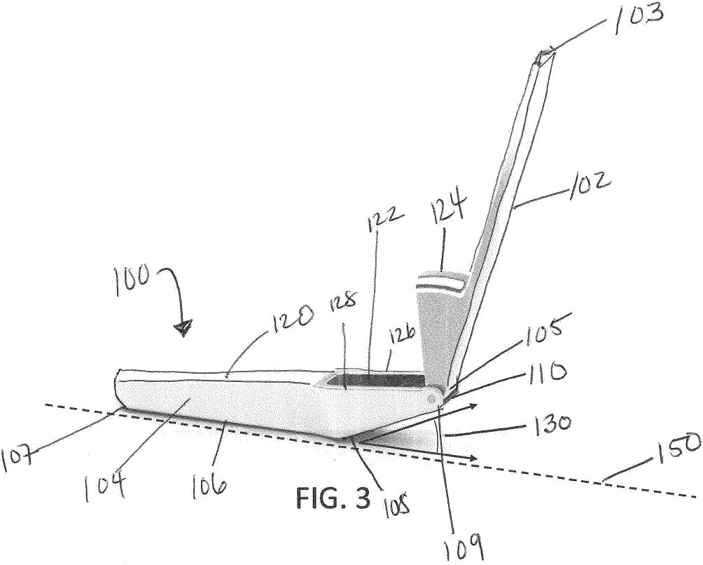

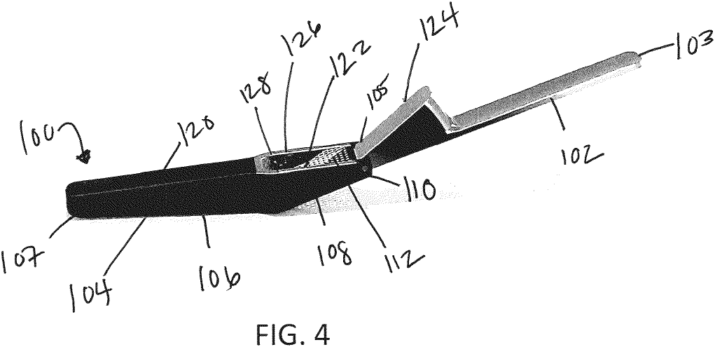

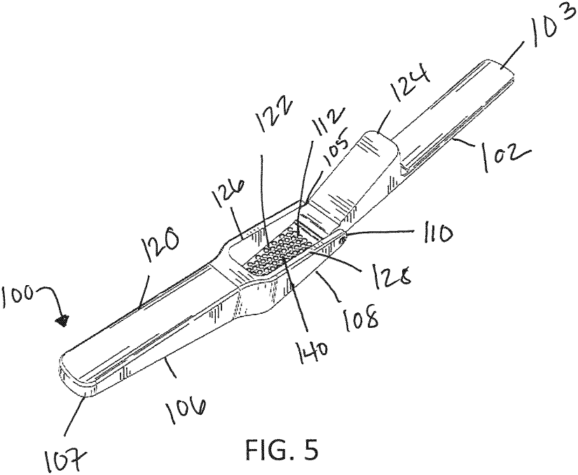

The garlic press also includes an elongated handle 102 which is substantially equal in length to the base 104. The handle 102 is shown in a closed position in FIGS. 1 and 2 and an open position in FIGS. 4 and 5. The handle 102 is shown moving between the open and closed positions in FIG. 3. In alternative embodiments, the handle 102 may be longer or shorter than the base 104. The handle has a first end 103 and a second end 105.

The base and handle can be composed of any known rigid or semi-rigid material. For example, the base and/or handle may be made of plastic, metal, glass filled nylon and/or a combination thereof. In a preferred embodiment, at least a portion of the base and/or handle is stainless steel. Additionally, in a preferred embodiment the handle is at least partially composed of a glass-filled nylon.

Both the base and the handle may have contoured surfaces for user comfort.

As shown better in FIG. 2, the second end 105 of handle portion 102 and the second end 109 of base portion 104 are connected at a joint 110. Joint 110 may be a pivot joint, pivotally connecting the handle portion 102 and the base portion 104. The pivot joint may include a pin 111. The connection or joint allows for pivoting movement of the handle with respect to the base about pin 111, such as swinging upward, as shown in further figures of the application. Alternative pivot joint or hinge arrangements known in the art including, but not limited to, those with mating or engaging tabs and recesses, may be used in place of the illustrated pivot joint and pin 111. The joint 110 may also be configured to allow the base and handle portions to be separated into two individual pieces, such as for cleaning.

As shown better in FIG. 3, the handle portion of the garlic press 100 may include a presser block 124. The presser block is sized to fit in a chamber 122 of the base, further detailed below, when the handle is in the closed position, as illustrated in FIGS. 1 and 2. The presser block is preferably adjacent to the joint or hinge 110 connecting the handle and the base. Preferably, at least the portion of the presser block is a metal or metallic material. In a preferred embodiment at least that portion (and possibly the whole handle) is stainless steel or another metal. As examples only, the presser block may be shaped as a triangular prism and may be solid or hollow.

As shown most clearly in FIG. 5, the base 104 includes a chamber 122 defined by walls 126 and 128. As noted previously, the chamber 122 is sized to receive the presser block 124 from the handle portion.

As also seen most clearly in FIG. 5, the bottom of the chamber 122 is defined by a grate 128, which serves as the bottom side of the base along the angled elevated portion 108. The grate has a plurality of openings or apertures 140. The apertures may be circular as shown in the figures, but can also include an oval, rectangular, triangular shape or any other known and useful shape. The grate 128 may be a permanent portion of the garlic press or may be removable and interchangeable. In the latter embodiment, grates with different aperture shapes can be interchanged in the garlic press for multiple uses. Grate 128 can also be constructed of a metal or metallic material or a plastic. In a preferred embodiment, the grate may be constructed of stainless steel. Preferably, in combination with a stainless steel presser block, the surfaces of the press contacting the garlic are stainless steel.

The described garlic press can be used in two different ways: (1) as a handheld tool or (2) as a countertop/surface device. With regard to the former, as with the traditional garlic press, the garlic press of the disclosure can be operated by gripping and squeezing the handle and the base together.

Alternatively, when the garlic press is used as a countertop/surface device, the user can place the device on the counter or other horizontal surface for use. More specifically, with reference to FIGS. 2 and 3, the bottom side of the first portion 106 of the base rests on the horizontal surface 150 of a counter or the like. The bottom side of the portion 106 may be flat or otherwise configured to rest on a surface without being flat, such as by having tabs, legs, supports or other surface shapes that are able to rest on a surface.

To load a clove of garlic into the garlic press, the user can hold the base 104 against surface 150 using one hand, and pivot the handle 102 with respect to the base (in the clockwise direction of FIGS. 1 and 3-5) into the open position illustrated in FIGS. 4 and 5 so that the chamber 122 is exposed. The user may then load a garlic clove into the chamber 122. The user can then pivot the handle 102 towards the base 104 (i.e. pivot the handle counter-clockwise in FIGS. 3-5 with respect to the base 104) so that the presser block 124 enters the chamber 122 of the base and crushes the garlic clove within the chamber 122 with a simple application of downward pressure (i.e. pressure towards surface 150) until the handle reaches the closed position of FIGS. 1 and 2. The surface 150 provides leverage via the bottom of base 104 and thus operation of the press requires less user strength and/or dexterity in comparison to the handheld operation of the device.

Another benefit of the disclosed garlic press is the ability of the user to leave the press on the counter or other surface, allowing the press to be continually used and the pressed garlic to be collected on the surface 150.

While the preferred embodiments of the invention have been shown and described, it will be apparent to those skilled in the art that changes and modifications may be made therein without departing from the spirit of the invention.

What is claimed is:

1. A garlic press comprising:
a base with a first portion adjacent to a first end and an angled elevated portion adjacent to a second end, said first portion of the base being configured to rest on a surface;
a handle pivotally joined to the angled elevated portion of the base at a joint so that the handle may pivot between an open position and a closed position;
said handle including a presser block;
said angled elevated portion of the base including a chamber defined by walls and a grate having a plurality of apertures, said chamber configured to receive the presser block when the handle is in the closed position.

2. The garlic press of claim 1, wherein the first portion features flat bottom side configured to rest on a surface.

3. The garlic press of claim 1, wherein the presser block is immediately adjacent to the joint.

4. The garlic press of claim 1, wherein the joint includes a pin.

5. The garlic press of claim 1, wherein the grate is an interchangeable and removable insert.

6. The garlic press of claim 1, wherein each of the plurality of apertures of the grate are round.

7. The garlic press of claim 1, wherein the grate is constructed from stainless steel.

8. The garlic press of claim 1, wherein the presser block is constructed from stainless steel.

9. The garlic press of claim 1, wherein the grate and the presser block are constructed from stainless steel.

10. The garlic press of claim 1, wherein the handle is contoured.

11. The garlic press of claim 1, wherein the handle is comprised of glass-filled nylon.

12. The garlic press of claim 1, wherein the base and handle feature an equal length.
